(19) United States
(12) Patent Application Publication
(10) Pub. No.: US 2008/0081562 A1
(43) Pub. Date: Apr. 3, 2008

(54) Mobile device system and mobile device

(76) Inventors: Hideki Nagata, Hachioji-shi (JP); Hiroyuki Minakata, Hachioji-shi (JP); Takayuki Ide, Fussa-shi (JP); Atsushi Kohashi, Akiruno-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/903,781

(22) Filed: Sep. 24, 2007

(30) Foreign Application Priority Data
Sep. 28, 2006 (JP) 2006-264746

(51) Int. Cl. H04B 7/00

(52) U.S. Cl. 455/41.2

(57) ABSTRACT

Even when a user carries a different combination of mobile devices on different days, these mobile devices can be flexibly handled as a group. A mobile device system includes a plurality of mobile devices, to each of which unique identification information is assigned. Each mobile device includes a communication unit configured to send the identification information assigned to the mobile device to other mobile devices in the vicinity and to receive identification information from the other mobile devices, and a group registration unit configured to register the identification information received by the communication unit from the other mobile devices as a group.

### BACKGROUND OF THE INVENTION

1. Field of the Invention

The present invention relates to a mobile device system and a mobile device that are capable of handing a plurality of mobile devices as a group.

This application is based on Japanese Patent Application No. 2006-264746, the content of which is incorporated herein by reference.

2. Description of Related Art

Recently, due to the diversification of information, when people go out, in many cases, they carry multiple mobile devices having various functions, such as mobile phones, laptop computers, information communication terminals, digital cameras, and music players (see Japanese Unexamined Patent Application, Publication No. 2002-9879).

Along with this trend, a technology for preventing users from forgetting to take their mobile device when going out and misplacing a mobile device outside the home has been proposed (see Japanese Unexamined Patent Application, Publication No. 2006-60544).

For example, Japanese Unexamined Patent Application, Publication No. 2006-60544 discloses a technology for periodically sending and receiving location information between a wireless key and a communication phone terminal, determining the distance therebetween on the basis of the information, and providing an alert when the determined distance becomes longer than a predetermined value when the user forgets to carry the mobile device.

### BRIEF SUMMARY OF THE INVENTION

A first aspect provides a mobile device system including a plurality of mobile devices, to each of which unique identification information is assigned, wherein each mobile device includes a communication unit configured to send the identification information assigned to the mobile device to other mobile devices in the vicinity and to receive identification information from the other mobile devices, and a group registration unit configured to register the identification information received by the communication unit from the other mobile devices as a group.

A second aspect provides a mobile device including a communication unit configured to send identification information assigned to the mobile device to other mobile devices in the vicinity and to receive identification information from the other mobile devices, and a group registration unit configured to register the identification information received by the communication unit from the other mobile devices as a group.

### BRIEF DESCRIPTION OF THE SEVERAL VIEWS OF THE DRAWINGS

FIG. 1 illustrates the structure of a mobile device system.

FIG. 2 illustrates common components included in each mobile device of the mobile device system.

FIG. 3 illustrates example information stored in a storage unit of a mobile phone.

FIG. 4 is a flow chart illustrating the steps of a misplacement detection process executed in a control unit.

FIG. 5 illustrates an example display when a personal digital assistant (PDA) and a personal computer are in the vicinity of the mobile phone.

### DETAILED DESCRIPTION OF THE INVENTION

The mobile device system according to the present invention includes a plurality of mobile devices, to each of which unique identification information is assigned, wherein each mobile device includes a communication unit configured to send the identification information assigned to the mobile device to other mobile devices in the vicinity and to receive identification information from the other mobile devices, and a group registration unit configured to register the identification information received by the communication unit from the other mobile devices as a group.

According to this structure, by operating the communication unit, the unique identification information assigned to each mobile device is sent from the communication unit to all of the other mobile devices in the communication range of the communication unit. In this way, the identification information of each mobile device is sent and received between the mobile devices in the vicinity. When each mobile device receives the identification information of the other mobile devices, the received identification information of the other mobile devices is registered as a group in the group registration unit. In this way, each mobile device can handle the plurality of mobile devices in the vicinity as a group. By forming a group, for example, a mobile device can be prevented from being misplaced, a common interface can be used for the mobile devices, and data held by the mobile devices can be linked.

The above-described communication unit may use wired or wireless communication. When using wireless communication, for example, a communication method such as Bluetooth, infrared communication, human-body communication, or near field communication (NFC) may be employed. When using wired communication, for example, a communication method using contact terminals may be employed.

In the above-described mobile device system, at least one of the mobile devices may include a notification unit configured to provide a notification of information about other mobile devices associated with the identification information registered as a group in the group registration unit.

According to this structure, since the notification unit provides a notification of information about other mobile devices associated with the identification information registered as a group in the group registration unit, a notification about the other mobile devices in the vicinity can be provided.

In this way, for example, when the user is carrying a first mobile device, a notification of other second mobile devices carried together with the first mobile device is provided from the notification unit. Thus, the user can view the notification unit to confirm the mobile devices he or she is carrying, without searching his or her clothes and bag.

As a notification method, for example, a display unit configured to visually provide a notification or an audio output unit configured to provide an audible notification may be employed.

In the above-described mobile device system, the group registration unit may link and register the identification information and information related to a mobile device specified by the identification information.

According to this structure, since the identification information and information related to a mobile device specified by the identification information are linked and registered in the group registration unit, the user can identify mobile devices in the vicinity by, for example, viewing the displayed names of the mobile devices, which are information linked to the identification information. By registering file information and so on held by a mobile device specified by the identification information, which is linked to the identification information, a plurality of mobile devices forming a group can have a wider range of application.

In the above-described mobile device system, a communication range of the communication unit may be set to a range in which the mobile devices are presumed to be carried together by a user.

According to this structure, second mobile devices identified by identification information received by the communication unit are presumed to be carried together with a first mobile device by the user. The communication range, for example, is approximately 1 to 10 m.

In the above-described mobile device system, the communication unit is, for example, a close-range communication unit.

According to this structure, since a close-range communication unit is used as the communication unit, second mobile devices identified by the identification information received by the communication unit are presumed to be carried together with a first mobile device by the user. The close-range communication unit is, for example, Bluetooth.

In the above-described mobile device system, each mobile device may include an announcing unit configured to provide a notification when the number of identification information items registered as a group in the group registration unit of the mobile device changes.

According to this structure, when a second mobile device that was in a predetermined range moves out the range due to misplacement and so on, the number of identification information items registered in the group registration unit changes, and a notification of this change is provided by the announcing unit. Therefore, by this notification, the user can quickly notice that a mobile device has been misplaced.

In the above-described mobile device system, each mobile device may include an announcing unit configured to provide a notification when the combination of identification information items registered as a group in the group registration unit of the mobile device changes.

According to this structure, when a second mobile device that was in a predetermined range moves out the range due to misplacement and so on, the combination of the identification information items registered to the group registration unit changes, and a notification of this change is provided by the announcing unit. Therefore, by this notification, the user can quickly notice that a mobile device has been misplaced.

In the above-described mobile device system, each mobile device may include an announcing unit configured to provide a notification when the identification information registered as a group in the group registration unit of the mobile device is no longer received by the communication unit.

According to this structure, when a second mobile device that was in a predetermined range moves out of range due to misplacement and so on, identification information is no longer received by the communication unit, and a notification of this change is provided by the announcing unit. Therefore, by this notification, the user can quickly notice that a mobile device has been misplaced.

The mobile device according to the present invention includes a communication unit configured to send identification information assigned to the mobile device to other mobile devices in the vicinity and to receive identification information from the other mobile devices, and a group registration unit configured to register the identification information received by the communication unit from the other mobile devices as a group.

According to this structure, the communication unit is operated to send identification information of the mobile device to other mobile devices in the vicinity. In this way, a notification of identification information about the mobile device can be sent to the other mobile devices in the vicinity. When identification information from the other mobile devices in the vicinity is received by operating the communication unit, the identification information is registered in the group registration unit. In this way, since the identification information of all the other mobile devices in the vicinity is registered as a group, the plurality of mobile devices in the vicinity can be handled as a group. By registering a group, for example, a mobile device can be prevented from being misplaced, and a common interface for the mobile devices and linking of data held by the mobile devices (i.e., data link) can be provided.

The communication unit may employ wired or wireless communication. When using wireless communication, for example, a communication method such as Bluetooth, infrared communication, human-body communication, or NFC may be employed. When using wired communication, for example, a communication method using contact terminals may be employed.

In the above-described mobile device, the first mobile device may include a notification unit configured to provide a notification of information about other mobile devices associated with the identification information registered as a group in the group registration unit.

According to this structure, since the notification unit provides a notification of information about second mobile devices in association with the identification information registered as a group in the group registration unit, a notification of the second mobile devices in the vicinity can be provided to a first mobile device.

In this way, for example, when the user is carrying the first mobile device, a notification of the second mobile devices carried together with the first mobile device is provided. Therefore, by viewing the notification unit, the user can confirm which mobile devices he or she is carrying, without searching his or her clothes and bag.

As a notification method, for example, a display unit configured to visually provide a notification or an audio output unit configured to provide an audible notification may be employed.

In the above-described mobile device, the group registration unit links and registers the identification information and information related to a mobile device specified by the identification information.

According to this structure, since the identification information and information related to a mobile device specified by the identification information are linked and registered in the group registration unit, the user can identify mobile devices in the vicinity by, for example, viewing displayed names of the mobile devices, which is information linked to the identification information. By registering file information held by a mobile device specified by the identification information, which is linked to the identification information, a plurality of mobile devices forming a group can have a wider range of application.

In the above-described mobile device, a communication range of the communication unit may be set to a range in which the mobile devices are presumed to be carried together by a user.

According to this structure, second mobile devices identified by the identification information received by the communication unit are presumed to be carried together with a first mobile device by the user. The communication range, for example, is approximately 1 to 10 m.

In the above-described mobile device, the communication unit is, for example, a close-range communication unit.

According to this structure, since a close-range communication unit is used as the communication unit, second mobile devices identified by the identification information received by the communication unit are presumed to be carried together with a first mobile device by the user. The close-range communication unit is, for example, Bluetooth.

The above-described mobile device may include an announcing unit configured to provide a notification when the number of identification information items registered as a group in the group registration unit of the mobile device changes.

According to this structure, when a second mobile device that was within a predetermined range moves out of range due to misplacement and so on, the number of identification information items registered in the group registration unit changes, and a notification of this change is provided by the announcing unit. Therefore, by this notification, the user can quickly notice that a mobile device has been misplaced.

The above-described mobile device may include an announcing unit configured to provide a notification when the combination of identification information items registered as a group in the group registration unit of the mobile device changes.

According to this structure, when a second mobile device that was within a predetermined range moves out of range due to misplacement and so on, the combination of the identification information items registered in the group registration unit changes, and a notification of this change is provided by the announcing unit. Therefore, by this notification, the user can quickly notice that a mobile device has been misplaced.

The above-described mobile device may include an announcing unit configured to provide a notification when the identification information registered as a group in the group registration unit of the mobile device is no longer received by the communication unit.

According to this structure, when a second mobile device that was within a predetermined range moves out of range due to misplacement and so on, identification information is no longer received by the communication unit, and a notification of this change is provided by the announcing unit. Therefore, by this notification, the user can quickly notice that a mobile device has been misplaced.

The various aspects described above can be used in combination within the scope of the present invention.

According to the above-described mobile device system or mobile device, even when the user carries a different combination of mobile devices on different days, the mobile devices carried together by the user on a particular day can be flexibly handled as a group.

Embodiments of a mobile device system will be described below with reference to the drawings.

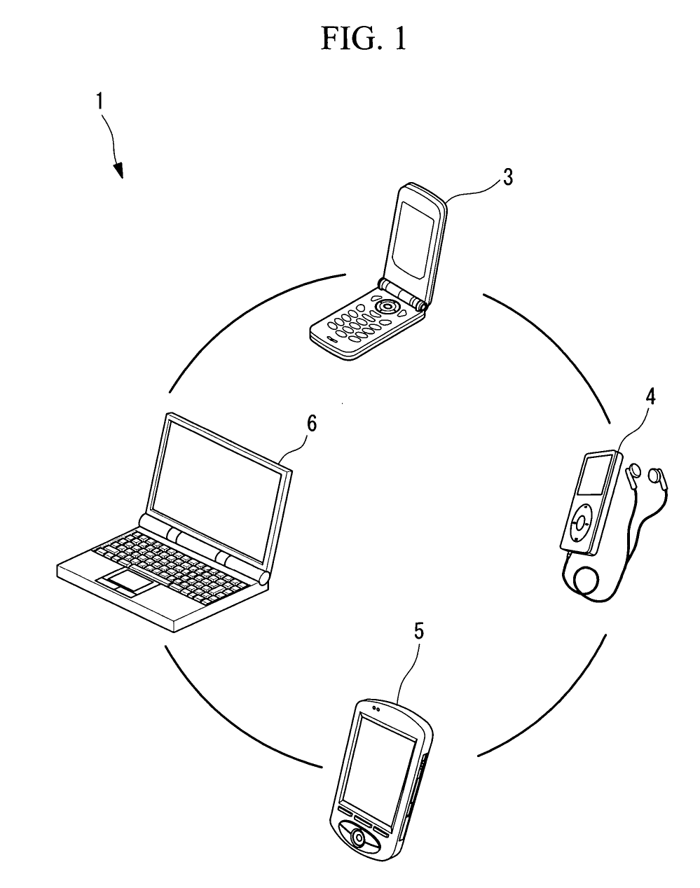

FIG. 1 illustrates an example structure of a mobile device system 1. As shown in the drawing, the mobile device system 1 includes a plurality of mobile devices or, more specifically, a mobile phone 3, a portable music player 4, a PDA 5, and a laptop computer (hereinafter referred to as ‘computer’) 6. Unique identification information is assigned to each mobile device.

These mobile devices are only examples, and any type of portable electronic device may be used in any combination. For example, an example of a mobile device is a wearable personal computer that is embedded in clothes.

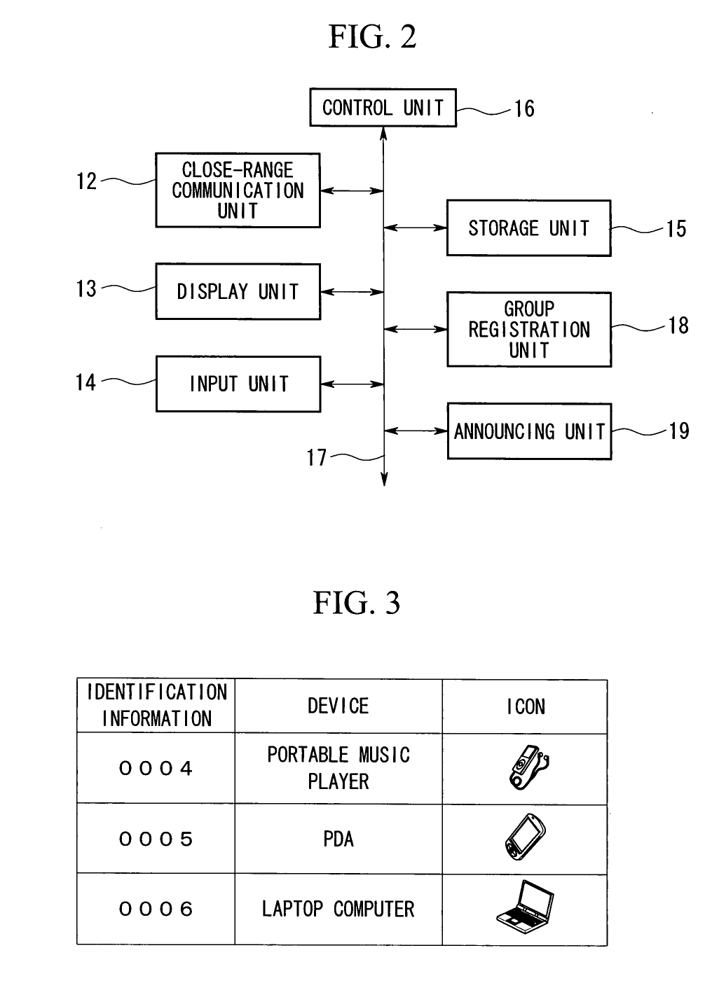

Each of the above-described mobile devices includes the following common components. More specifically, as illustrated in FIG. 2, each mobile device includes a close-range communication unit (communication unit) 12, a display unit (notification unit) 13, an input unit 14, a storage unit 15, a control unit (control device) 16, a group registration unit (group registration device) 18, and an announcing unit (announcing device). These units are mutually connected via a bus 17 and are capable of sending and receiving information between each other.

These components may be provided separately from components that are generally included in each mobile device, or the components that are generally included in each mobile device may also serve as the above-described components. For example, since the mobile phone 3 generally includes a communication unit, a display unit, and an input unit, any of these units that are the same as the common components may preferably be shared. This also applies to the other mobile devices.

The close-range communication unit 12 is capable of communicating with other mobile devices in the vicinity. It is preferable that the communication range of the close-range communication unit 12 be set to a range that allows communication between mobile devices being carried together, i.e., a range of approximately 1 to 10 m. A known close-range communication unit may be employed as the close-range communication unit 12. The close-range communication unit 12 may use wired or wireless communication. When using wireless communication, for example, a communication method such as Bluetooth, infrared communication, human-body communication, or near field communication (NFC) may be employed, When using wired communication, for example, a communication method using contact terminals may be employed.

The display unit 13 is, for example, a liquid crystal display. The input unit 14 is, for example, keys or buttons and functions as a man-machine interface.

The storage unit 15 holds information about the other mobile devices. More specifically, the storage unit 15 holds identification information for each mobile device. Various kinds of information, including the name of the mobile device and image data to be displayed on the display unit 13, are linked to the identification information of each mobile device. The image data displayed on the display unit 13 is, for example, icons or character information. For example, as shown in FIG. 3, identification information of the portable music player 4, the PDA 5, and the computer 6 is stored in the storage unit 15 of the mobile phone 3. The names and image data to be displayed on the display unit 13 are linked to the identification information of the other mobile devices. The control unit 16 performs overall control of the above-described units.

Identification information of the other mobile devices received by the close-range communication unit 12 is registered in the group registration unit 18.

When the combination of identification information of the other mobile devices received by the close-range communication unit 12 changes, the announcing unit 19 notifies the user. For example, a light-emitting diode (LED) that can be illuminated, a speaker that can emit sound, or a vibration motor that can be vibrated may be employed as the announcing unit 19, to notify the user.

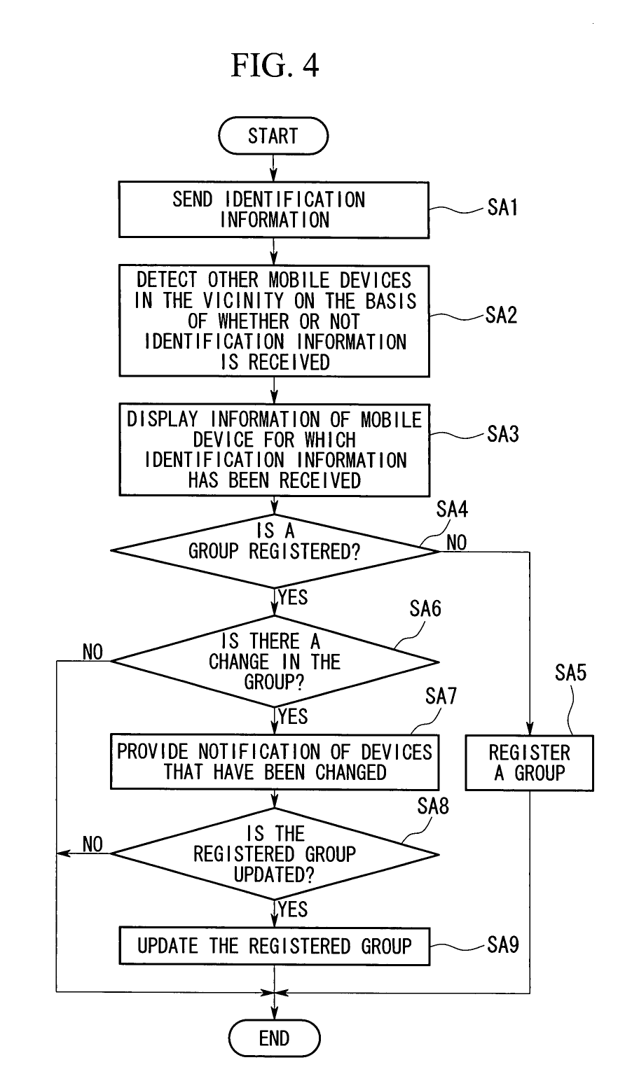

In the mobile devices having such common structures, the control units 16 repeatedly execute a misplacement detection process, as shown in FIG. 4, at predetermined intervals. Although the misplacement detection process described below is executed in the control unit 16 of each mobile device, for simplification, the process executed by the control unit 16 of the mobile phone 3 will be described as a representative example.

First, the control unit 16 of the mobile phone 3 sends an identification number “0003” assigned to the mobile phone 3 from the close-range communication unit 12 (Step SA1). In this way, the identification number “0003” of the mobile phone 3 is received by the other mobile devices within the communication range of the close-range communication unit 12 of the mobile phone 3. At the same time, the same process is executed in the control units 16 of the portable music player 4, the PDA 5, and the computer 6. In this way, identification numbers are sent and received between the mobile devices within the communication range of the close-range communication unit 12.

Subsequently, the control unit 16 detects other mobile devices in the vicinity on the basis of whether or not identification information of the other mobile devices has been received (Step SA2). Then, the control unit 16 acquires icons associated with the identification information received by the close-range communication unit 12 from the storage unit 15 and displays the icons on the display unit 13 (Step SA3). In this way, icons of the other mobile devices in the vicinity of the mobile phone 3 are displayed on the display unit 13.

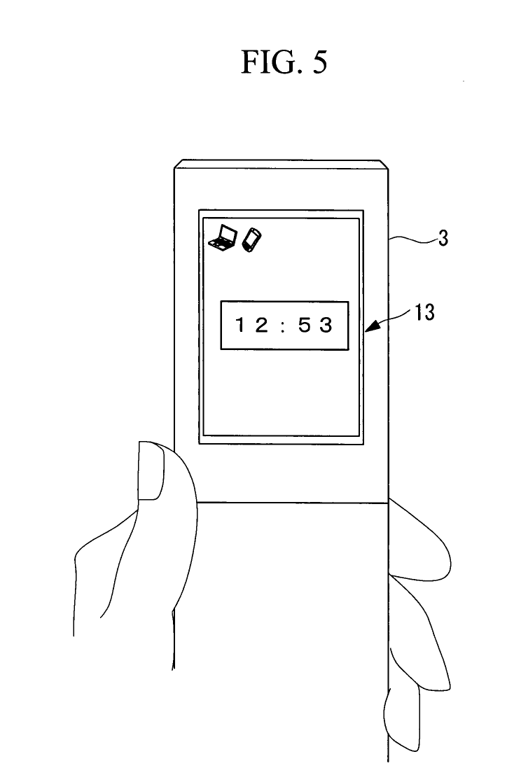

For example, FIG. 5 illustrates an example display on the display unit 13 when the PDA 5 and the computer 6 are detected in the vicinity. Accordingly, the user can view the display unit 13 to confirm that he or she is carrying the PDA 5 and the computer 6 and is not carrying the portable music player 4.

Subsequently, the control unit 16 determines whether or not a group has been registered in the group registration unit 18 (Step SA4). Since a group still has not yet been registered, the process proceeds to Step SA5. The identification information of the other mobile devices detected to be in the vicinity in Step SA2 is registered in the group registration unit 18, and the process ends. For example, if identification information of the PDA 5 and identification information of the computer 6 are received in Step SA2, the identification number “0005” of the PDA 5 and the identification number “0006” of the computer 6 are registered as a group in the group registration unit 18 of the mobile phone 3, and the process ends.

Next, after a predetermined amount of time, the control unit 16 executes the misplacement detection process shown in FIG. 4 again.

In this way, as described above, other mobile devices in the vicinity of the mobile phone 3 are detected, and information about these mobile devices is displayed on the display unit 13 (Steps SA1 to SA3). Then, in Step SA4, the control unit 16 determines whether or not a group has been registered in the group registration unit 18. Since a group is already registered, the process proceeds to Step SA6 so as to determine whether there is a change in the group status. More specifically, the control unit 16 determines whether or not the combination of mobile devices detected as being in the vicinity of the mobile phone 3 through the above-described process matches the combination of mobile devices registered in the group registration unit 18. As a result, for example, if the PDA 5 and the computer 6 are detected to be in the vicinity through the process, it is determined in Step SA6 that there is no change in the group status, and then the process ends.

When there is a change in the combination of mobile devices detected to be in the vicinity of the mobile phone 3 and when the combination of mobile devices detected in Step SA2 differs from the combination of mobile devices registered as a group, the control unit 16 operates the announcing unit 19 to notify the user (Step SA7). In this way, since the user is notified when the number of mobile devices that he or she is carrying changes, the user can quickly notice a misplaced mobile device. In such a case, since the mobile devices currently being carried by the user are displayed on the display unit 13, the user can view the display and determine which mobile device he or she has misplaced.

Subsequently, the control unit 16 queries the user as to whether or not to update the registered group (Step SA8). This inquiry is carried out by, for example, displaying a message “Update group registration?” on the display unit 13 or providing an audio message. As a result, if there is an input for updating the registered group, the mobile devices detected in Step SA2 of the process are registered as a group in the group registration unit 18 (Step SA9), and then the process ends. If there is no input for updating the registered group in Step SA8, the control unit 16 does not update the registered group, and then the process is completed.

Here, for example, when the user decides to increase the number of mobile devices he or she is carrying or when the user leaves a mobile device behind, then, a misplacement of a mobile device must be determined on the basis of the new combination of mobile devices. If the registered group were not updated, the same notification would be provided the next time the process is executed, and the user would be bothered by this notification. Thus, as described above, convenience can be enhanced by allowing the user to determine whether or not to update the registered group.

Then, the control unit 16 repeatedly executes the misplacement detection process, as shown in FIG. 4, at predetermined intervals to periodically detect misplacement of a mobile device and notifies the result to the user.

As described above, in this mobile device system 1, second mobile devices that are detected to be in the vicinity of a first mobile device are registered as a group. Thus, even when the user carries a different combination of mobile devices on different days, the mobile devices carried together by the user on a particular day can be flexibly handled as a group.

When there is a change in the group status registered in the group registration unit 18, the announcing unit 19 notifies the user. Thus, the user can quickly notice when a mobile device is misplaced.

According to this mobile device system 1, since information about second mobile devices in the vicinity of a first mobile device is displayed on the display unit 13 of the first mobile device, the user can confirm which second mobile devices he or she is carrying by viewing the display unit 13 of the first mobile device, without searching his or her bag and clothes. Since information about second mobile devices outside a predetermined range of the first mobile device is not displayed on the display unit 13, for example, when the announcing unit 19 provides a notification, the user can determine which of the second mobile devices has been misplaced by viewing the display unit 13.

Furthermore, since information on second mobile devices in the vicinity of a first mobile device is displayed on the display units 13 of not only one mobile device but all of the first and second mobile devices, the user can easily confirm the mobile devices he or she is carrying together by viewing the display unit 13 of any of the mobile devices.

According to this embodiment, the user is notified about second mobile devices within a predetermined range of a first mobile device by displaying such information on the display unit 13. Instead, however, the user may be notified by an audio message. In such a case, in addition to the components shown in FIG. 2, an audio output unit configured to output sound, such as a speaker, is provided.

According to this embodiment, in Step SA6 of FIG. 4, whether or not a group status has changed is determined on the basis of whether or not the combination of identification information registered in the group registration unit 18 has changed. Instead, however, it can be determined that the group status has changed when the number of identification information items registered in the group registration unit 18 is changed. Furthermore, when identification information registered in the group registration unit 18 is not received, the announcing unit 19 can notify the user.

In this way, the processing load can be reduced compared with a case where the identification information items are compared.

Embodiments of the misplacement detection process have been described above. Instead, for example, a common interface (e.g., network connection and screen input) for the mobile devices and linking of data held by the mobile devices (i.e., data link) can be provided by registering, as a group, identification information of a plurality of second mobile devices in the vicinity of a first mobile device.

Embodiments of the mobile device system and mobile devices have been described above in detail with reference with the drawings. However, specific structures are not limited to the above-described embodiments, and modifications are possible so long as they do not depart from the spirit of the invention.

What is claimed is:

1. A mobile device system comprising:
a plurality of mobile devices, to each of which unique identification information is assigned,
wherein each mobile device includes
a communication unit configured to send the identification information assigned to the mobile device to other mobile devices in the vicinity and to receive identification information from the other mobile devices, and
a group registration unit configured to register the identification information received by the communication unit from the other mobile devices as a group.

2. The mobile device system according to claim 1, wherein at least one of the mobile devices includes a notification unit configured to provide a notification of information about other mobile devices associated with the identification information registered as a group in the group registration unit.

3. The mobile device system according to claim 1, wherein the group registration unit links and registers the identification information and information related to a mobile device specified by the identification information.

4. The mobile device system according to claims 1, wherein a communication range of the communication unit is set to a range in which the mobile devices are presumed to be carried together by a user.

5. The mobile device system according to claims 1, wherein the communication unit is a close-range communication unit.

6. The mobile device system according to claims 1, wherein each mobile device includes an announcing unit configured to provide a notification when the number of identification information items registered as a group in the group registration unit of the mobile device changes.

7. The mobile device system according to claims 1, wherein each mobile device includes an announcing unit configured to provide a notification when the combination of identification information items registered as a group in the group registration unit of the mobile device changes.

8. The mobile device system according to claims 1, wherein each mobile device includes an announcing unit configured to provide a notification when the identification information registered as a group in the group registration unit of the mobile device is no longer received by the communication unit.

9. A mobile device comprising:
a communication unit configured to send identification information assigned to the mobile device to other mobile devices in the vicinity and to receive identification information from the other mobile devices; and
a group registration unit configured to register the identification information received by the communication unit from the other mobile devices as a group.

10. The mobile device according to claim 9, further comprising:
a notification unit configured to provide a notification of information about other mobile devices associated with the identification information registered as a group in the group registration unit.

11. The mobile device according to claim 9, wherein the group registration unit links and registers the identification information and information related to a mobile device specified by the identification information.

12. The mobile device according to claims 9, wherein a communication range of the communication unit is set to a range in which the mobile devices are presumed to be carried together by a user.

13. The mobile device according to claims 9, wherein the communication unit is a close-range communication unit.

14. The mobile device according to claims 9, further comprising:
an announcing unit configured to provide a notification when the number of identification information items registered as a group in the group registration unit of the mobile device changes.

15. The mobile device according to claims 9, further comprising:
an announcing unit configured to provide a notification when the combination of identification information items registered as a group in the group registration unit of the mobile device changes.

16. The mobile device according to claims 9, further comprising:
an announcing unit configured to provide a notification when the identification information registered as a group in the group registration unit of the mobile device is no longer received by the communication unit.
